(19) United States
(12) Patent Application Publication
(10) Pub. No.: US 2020/0402151 A1
(43) Pub. Date: Dec. 24, 2020

(54) SERVER APPARATUS FOR PROMOTING LENDING OR BORROWING OF PORTABLE ELECTRIC POWER SUPPLY

(71) Applicant: HONDA MOTOR CO., LTD., Tokyo (JP)

(72) Inventors: Nobuyuki Sasaki, Wako-shi (JP); Sho Takada, Wako-shi (JP); Mitsuhiro Ito, Wako-shi (JP); Mio Oshima, Wako-shi (JP); Yoshihiro Matsunaga, Wako-shi (JP); Ryo Oshima, Wako-shi (JP)

(73) Assignee: HONDA MOTOR CO., LTD., Tokyo (JP)

(21) Appl. No.: 17/013,998

(22) Filed: Sep. 8, 2020

Related U.S. Application Data
(63) Continuation of application No. PCT/JP2018/044962, filed on Dec. 6, 2018.

(30) Foreign Application Priority Data
Mar. 20, 2018 (JP) 2018-052592

(51) Int. Cl. G06Q 30/06; G06Q 40/04; G06Q 50/06; G06Q 50/00; B60L 53/66; G06F 16/9535; G01C 21/36; B60L 53/68

(52) U.S. Cl. CPC G06Q 30/0645; G06Q 40/04; G06Q 50/06; B60L 53/68; B60L 53/665; G06F 16/9535; G01C 21/3679; G06Q 50/01

(57) ABSTRACT

A server receives, from a communication terminal of a first user, reception request information that indicates a request for reception of electric power, transmits, to a plurality of communication terminals, solicitation information for soliciting a user who wishes to supply the electric power based on the reception request information, receives, from a communication terminal of a second user, application information as a response to the solicitation information, and transmits the application information of the second user to the communication terminal of the first user. Each of the reception request information and the solicitation information includes information related to a requested date/time of reception of the electric power, a requested place of reception of the electric power, and an electric power amount of a portable electric power supply apparatus that supplies the electric power.

### CROSS-REFERENCE TO RELATED APPLICATION(S)

This application is a continuation of International Patent Application No. PCT/JP2018/044962 filed on Dec. 6, 2018, which claims priority to and the benefit of Japanese Patent Application No. 2018-052592 filed on Mar. 20, 2018, the entire disclosures of which are incorporated herein by reference.

### BACKGROUND OF THE INVENTION

### Field of the Invention

The present invention relates to a server apparatus that promotes lending or borrowing of a portable electric power supply apparatus.

### Description of the Related Art

PTL 1 describes guiding of an electric vehicle equipped with a storage battery for travelling purpose to a charging facility with a low electric power price. It is predicted that such an electric vehicle and charging facility will increase in number in the future.

PTL 1: Japanese Patent Laid-Open No. 2011-128871

An electric vehicle can supply electric power of a storage battery for travelling purpose to an external home appliance. Therefore, it would be possible for an electric vehicle to move to the location of a user who wishes to receive electric power, and supply electric power. However, there are no functions for matching between a user who wishes to supply electric power and a user who wishes to receive electric power.

Meanwhile, portable storage batteries are becoming widespread. In recent years, in the United States and the like, an increasing number of camping enthusiasts are bringing a portable electric power generator and a portable storage battery to a campsite to use home appliances. In the meantime, if an engine runs out of fuel or has an insufficient amount of charge, a camping enthusiast can no longer use home appliances. As a large number of camping enthusiasts gather in a campsite, there may be a case where a portable storage battery of one camping enthusiast is not capable of supplying electric power while a portable storage battery of another camping enthusiast is capable of supplying electric power.

Furthermore, such a portable storage battery is expected to become widespread as a power source for a market stall. When the amount of charge of a portable storage battery for a market stall has decreased, an operator of the market stall may wish to charge from a portable storage battery of another user. In this way, the spread of a portable storage battery will probably boost demand for lending/borrowing of a portable storage battery between users. One user may wish to earn remuneration by supplying electric power left in his/her portable storage battery to another user. Another user may wish to receive a supply of electric power even at the cost of compensation.

For example, if there is a system that enables a user who wishes to receive electric power to demand another user to provide electric power, it would be possible to promote lending and borrowing of a portable electric power supply apparatus. The present invention promotes lending and borrowing of a portable electric power supply apparatus.

### SUMMARY OF THE INVENTION

According to the present invention, provided is, for example, a server apparatus characterized by including: first receiver for receiving, from a communication terminal of a first user, reception request information that indicates a request for reception of electric power; first transmitter for transmitting, to a plurality of communication terminals, solicitation information for soliciting a user who wishes to supply the electric power based on the reception request information among users who own portable electric power supply apparatuses; second receiver for receiving, from a communication terminal of a second user, application information as a response to the solicitation information; and second transmitter for transmitting the application information of the second user to the communication terminal of the first user.

Further features of the present invention will become apparent from the following description of exemplary embodiments (with reference to the attached drawings).

### BRIEF DESCRIPTION OF THE DRAWINGS

FIG. 1 is a diagram showing a lending system for a portable electric power supply apparatus.

FIG. 2 is a diagram showing a portable electric power supply apparatus.

FIG. 3 is a diagram showing a portable electric power supply apparatus.

FIG. 4 is a block diagram showing a communication terminal.

FIG. 5 is a diagram showing a server apparatus.

FIG. 6 is a diagram showing a user database.

FIG. 7 is a sequence diagram showing a method of lending a portable electric power supply apparatus (an electric power mediation method).

FIG. 8 is a flowchart showing an electric power reception method.

FIG. 9 is a flowchart showing a supply application method.

FIG. 10 is a flowchart showing an electric power mediation method.

### DESCRIPTION OF THE EMBODIMENTS

<Lending System>

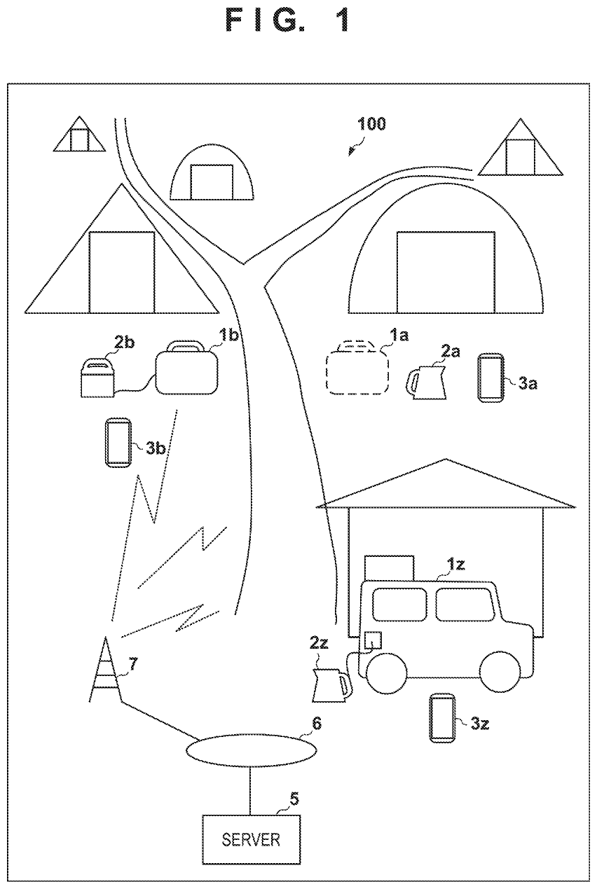

FIG. 1 shows a lending system 100 for a portable electric power supply apparatus. The lending system 100 may also be referred to as an electric power mediation system. Lower-case alphabetical letters that are appended to the end of reference signs are given to distinguish between identical or similar apparatuses. These alphabetical letters are omitted in the explanation of matters that are common to a plurality of apparatuses. Although the following describes lending of a portable electric power supply apparatus 1 on a campsite, this is merely an example. The present invention is also applicable to a scenario in which a portable electric power supply apparatus 1 is lent to an operator of a market stall that has been mentioned earlier.

On the campsite, a plurality of camping enthusiasts (users) set up tents and stay in cottages or the like. A first user a owns a load 2a and a communication terminal 3a. The first user a does not own a portable electric power supply apparatus 1a. Alternatively, it is assumed that the first user a cannot supply sufficient electric power to the load 2a with the portable electric power supply apparatus 1a. In this case, the first user a can make a request for reception of electric power via a server 5. Long before the first user a arrives at the campsite, he/she transmits a reception request to the server 5 via the communication terminal 3a at home. Alternatively, the first user a transmits a reception request to the server 5 via the communication terminal 3a on the campsite. A second user b owns a portable electric power supply apparatus 1b, a load 2b, and a communication terminal 3b. The portable electric power supply apparatus 1b is a portable electricity storage apparatus or a portable engine-driven electric power generator. A third user z owns a portable electric power supply apparatus 1z, a load 2z, and a communication terminal 3z. The portable electric power supply apparatus 1z is an electric vehicle that can travel using a motor, such as an electric car and an electric motorcycle, and can supply electric power to the load 2z and the like. In the United States and the like, there are many campsites with a land area of over 100,000 square kilometers, and a plurality of users may be distanced from one another by approximately several kilometers. On such campsites, commercial alternating-current power sources may not exist, and each user may bring a power source to a tent site by him/herself. Here, the first user a wishes to borrow a portable electric power supply apparatus 1 of another user, while the second user b and the third user z do not mind lending the portable electric power supply apparatuses 1 to another user.

The server 5 is a computer installed on the campsite or outside the campsite. The server 5 may communicate with the portable electric power supply apparatuses 1a, 1b, 1z and the communication terminals 3a, 3b, 3z via a network 6 and a wireless base station 7. The portable electric power supply apparatuses 1a, 1b, 1z may communicate with the server 5 via the corresponding communication terminals 3a, 3b, 3z, respectively. Alternatively, when the communication terminals 3a, 3b, 3z are capable of communicating with the server 5, the portable electric power supply apparatuses 1a, 1b, 1z may not be capable of communicating with the server 5. Furthermore, the portable electric power supply apparatuses 1a, 1b, 1z and the communication terminals 3a, 3b, 3z may be integrated. The wireless base station 7 may be a base station for cellular communication, or may be a wireless LAN access point. The server 5 mediates lending/borrowing of the portable electric power supply apparatuses 1 among a plurality of users.

<Portable Electric Power Supply Apparatus>

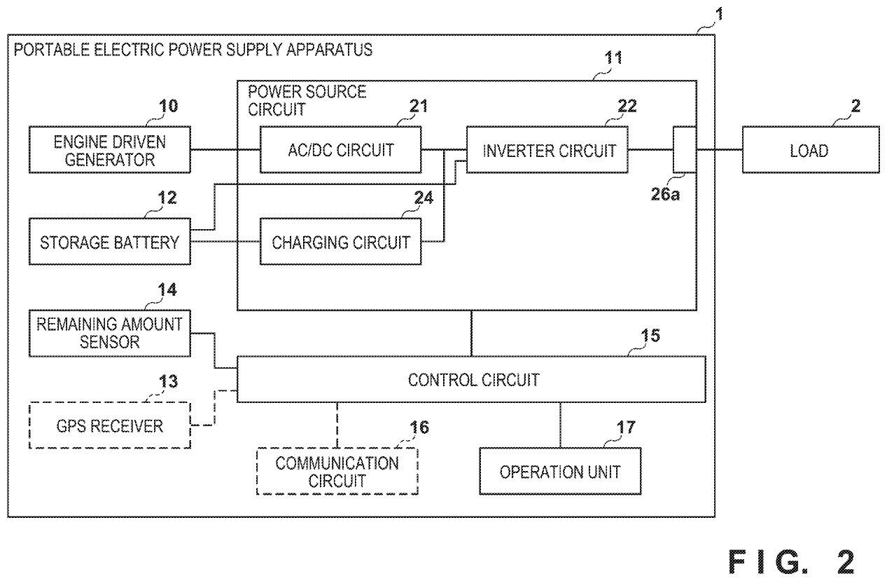

FIG. 2 is a block diagram showing a portable electric power supply apparatus 1. An engine driven generator 10 includes an engine that operates in accordance with fuel supplied from a fuel tank, and an electric power generator that generates electricity when driven by this engine. Examples of the fuel include gasoline, liquefied petroleum gas, hydrogen, and the like. A power source circuit 11 is a circuit that converts the voltage produced by the electricity generation of the engine driven generator 10 into predetermined alternating current or direct current. An AC/DC circuit 21 includes, for example, a rectification/smoothing circuit that generates direct current by rectifying and smoothing alternating current produced by the electricity generation of the engine driven generator 10. An inverter circuit 22 is a circuit that converts direct current output from the AC/DC circuit 21 or a storage battery 12 into alternating current with a stable predetermined frequency. The inverter circuit 22 may convert direct current output from the storage battery 12 into alternating current with a stable predetermined frequency. An AC terminal 26a is an AC outlet terminal to which a load 2 is connected. A charging circuit 24 charges the storage battery 12 using electric power output from the AC/DC circuit 21. A control circuit 15 is a circuit that controls the power source circuit 11, a GPS (Global Positioning System) receiver 13, a communication circuit 16, an operation unit 17, and the like. The GPS receiver 13 performs position measurement by receiving signals transmitted from a GPS satellite, and outputs the result of the position measurement (e.g., a latitude and a longitude) to the control circuit 15. The communication circuit 16 communicates with a smartphone and a PC (personal computer) and communicates with the server 5 via wired lines or wirelessly. The operation unit 17 includes a display apparatus and an input apparatus. A remaining amount sensor 14 measures the stored electricity amount (e.g., voltage) of the storage battery 12, and outputs the result of measurement to the control circuit 15. The voltage of the storage battery 12 decreases as the stored electricity amount of the storage battery 12 decreases. Therefore, the voltage of the storage battery 12 gives an indication of the stored electricity amount of the storage battery 12. The control circuit 15 transmits stored electricity information indicating the stored electricity amount of the storage battery 12, periodically or in accordance with a request signal from the server 5, to the server 5. As a result, the server 5 can collect the electricity storage statuses of various users.

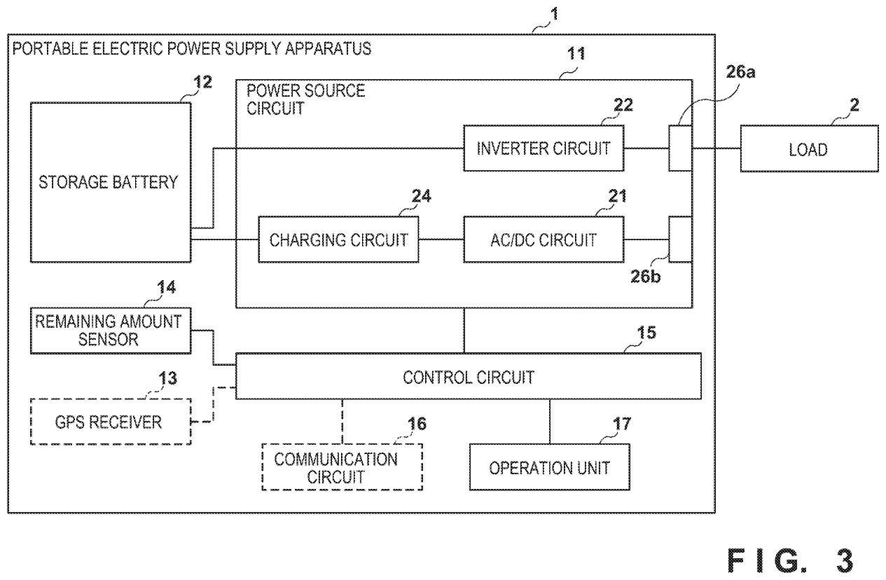

FIG. 3 is a block diagram showing a portable electric power supply apparatus 1 that does not include an engine driven generator 10. The portable electric power supply apparatus 1 of FIG. 2 and the portable electric power supply apparatus 1 of FIG. 3 are configured in the same way, except for a portion related to the engine driven generator 10. An AC/DC circuit 21 converts alternating current input from an AC terminal 26b into direct current, and supplies the direct current to a charging circuit 24. The AC terminal 26b is an AC inlet terminal. The charging circuit 24 charges a storage battery 12 using electric power supplied from the AC/DC circuit 21. A user would charge the portable electric power supply apparatus 1 at home and the like, and then bring the same to the campsite.

In FIG. 2 and FIG. 3, when the portable electric power supply apparatus 1 is an electric vehicle, the portable electric power supply apparatus 1 includes wheels, a motor that drives the wheels, a driving wheel, a motor that drives the driving wheel, a brake, a motor that drives the brake, and so forth. Based on position information of the current location obtained by a GPS receiver 13 and on position information of the destination designated by the server 5, a control circuit 15 guides or drives the electric vehicle to the destination. The portable electric power supply apparatus 1 may be a drone (e.g., an unmanned aircraft or an unmanned surface vessel).

<Communication Terminal>

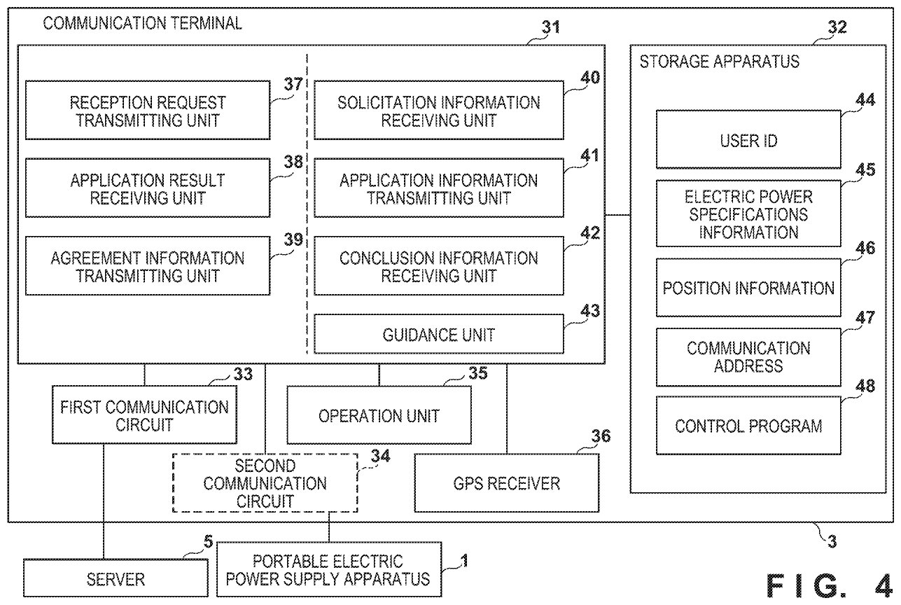

FIG. 4 is a block diagram of a communication terminal. A CPU 31 has a plurality of functions that are realized by executing a control program 48 stored in a storage apparatus 32. Note that a part or all of these functions may be realized by a hardware circuit, such as a DSP (digital signal processor) and an FPGA (field-programmable gate array). Note that the CPU 31 is a processor circuitry that may have one or more processors, and/or one or more CPU cores, ASIC (application specific integrated circuits) and/or FPGA (field programmable gate array), and/or one or more combinations of them. The storage apparatus 32 includes a memory, such as a RAM and a ROM. A first communication circuit 33 is a communication circuit that communicates with the server 5 via a network. A second communication circuit 34, which is an option, is a communication circuit that communicates with a portable electric power supply apparatus 1. An operation unit 35 includes a display apparatus and an input apparatus. A GPS receiver 36 measures the position of a communication terminal 3. The storage apparatus 32 further stores a user ID 44, electric power specifications information 45, position information 46, a communication address 47, and the like. The user ID 44 is identification information of a user. The position information 46 is information that indicates a geographical position (e.g., a latitude and a longitude, or an address) of the communication terminal 3 obtained by the GPS receiver. The communication address 47 is a communication address allocated to the user or the communication terminal 3. The communication address 47 is a communication address that is used in transmitting a message to the user from another user or the server 5. The communication address 47 is, for example, an electronic mail address, an address of an SNS service, an address for communicating with an application executed on the communication terminal 3 or the portable electric power supply apparatus 1, or the like. The electric power specifications information 45 is specifications information of the portable electric power supply apparatus 1. The specifications information include information indicating the electric power amount that can be supplied by the portable electric power supply apparatus 1.

A reception request transmitting unit 37, an application result receiving unit 38, and an agreement information transmitting unit 39 are used when the user wishes to borrow a portable electric power supply apparatus 1 or receive electric power. The reception request transmitting unit 37 transmits reception request information to the server 5 by controlling the first communication circuit 33. The reception request information is information indicating that the user wishes to receive electric power. The reception request information includes, for example, a requested date/time of reception of electric power, a requested place of reception of electric power, information related to the electric power amount (the stored electricity amount and the electricity generation performance) of the portable electric power supply apparatus that supplies electric power, compensation information indicating the compensation requested by the user, and the like, which have been input via the operation unit 35. The reception request information may further include the user ID 44, the position information 46, the communication address 47, and the like. The application result receiving unit 38 receives application information transmitted from the server 5 by controlling the first communication circuit 33. The application information includes information of another user who wishes to supply electric power. The agreement information transmitting unit 39 transmits agreement information to the server 5 by controlling the first communication circuit 33. The agreement information is information indicating that the user agrees with an application from another user. The agreement information transmitting unit 39 may transmit refusal information to the server 5. The refusal information is information indicating that the user refuses an application from another user.

A solicitation information receiving unit 40, an application information transmitting unit 41, a conclusion information receiving unit 42, a guidance unit 43, and the like are used when the user wishes to lend the portable electric power supply apparatus 1 or supply electric power. The solicitation information receiving unit 40 receives solicitation information transmitted from the server 5 by controlling the first communication circuit 33. The solicitation information is information for soliciting a user who is prepared to supply electric power to another user. The solicitation information includes, for example, a requested date/time of reception of electric power, a requested place of reception of electric power, information related to the electric power amount of the portable electric power supply apparatus that supplies electric power, compensation information indicating the compensation requested by the user, and the like. The application information transmitting unit 41 transmits application information to the server 5 by controlling the first communication circuit 33. The application information is information that includes the user ID 44, the electric power specifications information 45, the position information 46, the communication address 47, and the like. The application information is a response to the solicitation information. The application information transmitting unit 41 may include the user ID 44, the electric power specifications information 45, the position information 46, and the communication address 47. The conclusion information receiving unit 42 receives agreement information or refusal information from the server 5 by controlling the first communication circuit 33. The guidance unit 43 receives guidance information from the server 5 by controlling the first communication circuit 33. The guidance unit 43 guides the user to the location of another user in accordance with the guidance information and the position information 46 (a navigation function).

<Server 5>

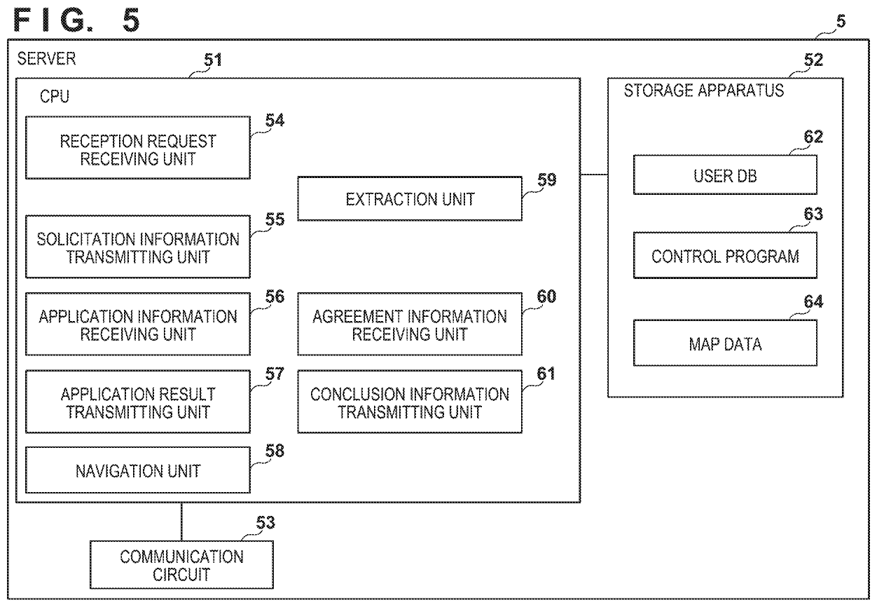

FIG. 5 is a block diagram showing the functions of the server 5. A CPU 51 realizes various functions by executing a control program 63 stored in a storage apparatus 52. Note that a part or all of these functions may be realized by a hardware circuit, such as a DSP and an FPGA. Note that the CPU 51 is a processor circuitry that may have one or more processors, and/or one or more CPU cores, ASIC (application specific integrated circuits) and/or FPGA (field programmable gate array), and/or one or more combinations of them. The storage apparatus 52 includes a RAM, a ROM, an HDD (hard disk drive), an SSD (silicon state disk), and the like. A communication circuit 53 is a communication circuit that communicates with a portable electric power supply apparatus 1 and a communication terminal 3 via a network.

A reception request receiving unit 54 receives reception request information from a communication terminal 3 by controlling the communication circuit 53. A solicitation information transmitting unit 55 generates solicitation information based on the reception request information, and transmits the solicitation information to a plurality of communication terminals by controlling the communication circuit 53. For example, the solicitation information transmitting unit 55 causes an extraction unit 59 to extract communication addresses of a plurality of communication terminals 3 that serve as the addressees of the solicitation information. The extraction unit 59 extracts communication addresses of a plurality of communication terminals 3 that match the reception request information. For example, position information of the communication terminal 3 that transmitted the reception request information is compared with position information of users who are registered with a user DB 62, and communication addresses of a plurality of communication terminals 3 that are close to the communication terminal 3 that transmitted the reception request information are obtained. Furthermore, the extraction unit 59 narrows down to users who own portable electric power supply apparatuses 1 that can provide electric power of the electric power amount requested by the reception request information. The solicitation information contains conditions (e.g., the requested place and date/time of reception, the electric power amount, the price of compensation, and the like) that are included in the reception request information. An application information receiving unit 56 receives application information from a communication terminal 3 as a response to the solicitation information by controlling the communication circuit 53. An application result transmitting unit 57 generates an application result based on the application information, and transmits the application result to the communication terminal 3 by controlling the communication circuit 53. When there is an applicant, the application result may include, for example, the name (nickname) and contact information of a user who applied. When there are a plurality of applicants, a user who wishes to be a recipient may select one of the applicants or negotiate with a plurality of applicants based on the application result. In this case, the application result includes communication addresses of the applicants. When the number of applicants is zero, the application result includes information indicating that the number of applicants is zero. The user who wishes to be the recipient may increase the price of compensation and transmit the reception request information again. An agreement information receiving unit 60 receives agreement information or refusal information, which is a response to the application result, via the communication circuit 53. A conclusion information transmitting unit 61 transmits the agreement information or the refusal information, which was received from the user who wishes to be the recipient, to the communication terminal 3 of the applicant. Based on the requested date/time of reception, the requested place of reception, and position information of the applicant, a navigation unit 58 generates guidance information that prompts the applicant to be able to arrive at the requested place of reception by the requested date/time of reception, and transmits the guidance information to the communication address of the applicant. For example, once a lender of a portable electric power supply apparatus 1 (an electric power supplier) has been determined, based on position information of the communication terminal 3 of the electric power supplier, the requested place of reception, and map data 64, the navigation unit 58 searches for and extracts a route from the position of the communication terminal 3 to the requested place of reception. The navigation unit 58 further determines the departure time of the electric power supplier based on the extracted route and the requested date/time of reception. The navigation unit 58 transmits the guidance information including the departure time, route information, and the like to the communication terminal 3 of the electric power supplier.

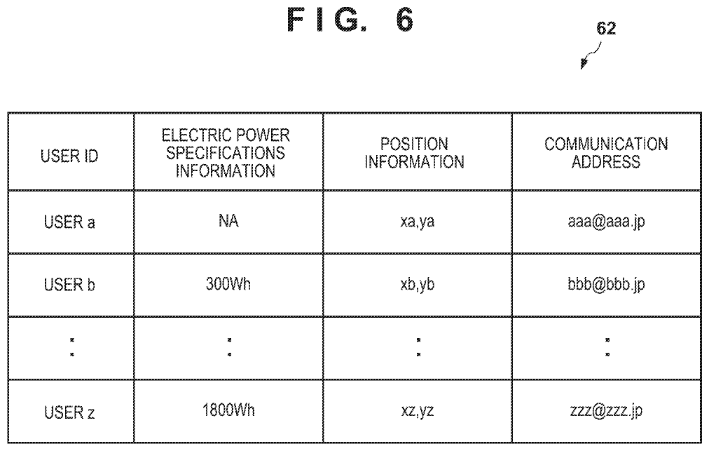

FIG. 6 shows a storage structure of the user DB 62. The user DB 62 holds information related to users who have subscribed to a lending/borrowing service for portable electric power supply apparatuses. A user ID is identification information of a user. The user DB 62 may further hold authentication information, such as a password. Electric power specifications information may include, for example, a nominal charge amount (stored electricity amount) of a storage battery of a portable electric power supply apparatus 1, the maximum output of an electric engine-driven generator, and the maximum electric power amount when a full load of fuel is provided. Position information is information indicating a geographical position of a communication terminal 3 or a portable electric power supply apparatus 1. A communication address is an electronic mail address, an address of an SNS service, or an address for communicating with an application executed on a communication terminal 3 or a portable electric power supply apparatus 1.

<Lending Sequence I>

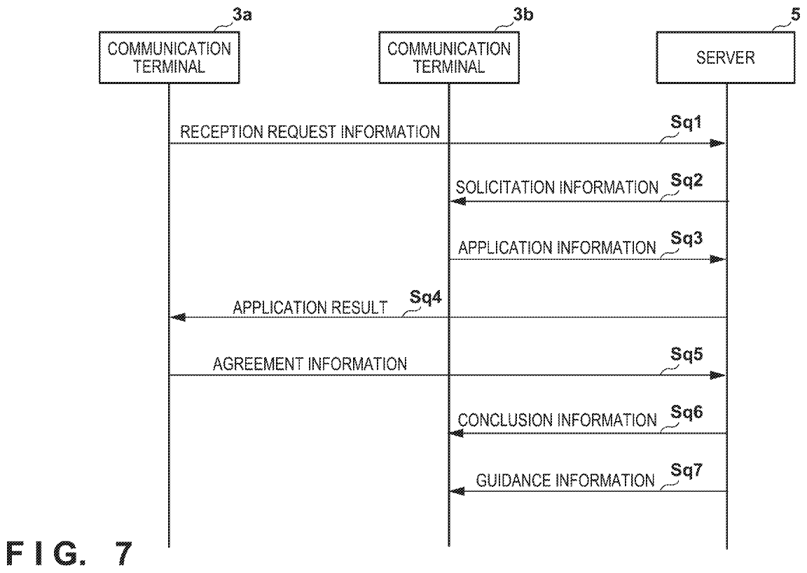

FIG. 7 is a sequence diagram showing a method of lending a portable electric power supply apparatus (an electric power supply method). Here, the first user a is a user who wishes to receive electric power. The second user b is a user who wishes to supply electric power.

In Sq1, the communication terminal 3a transmits reception request information to the server 5, and the server 5 receives the reception request information.

In Sq2, the server 5 generates solicitation information based on the reception request information, and transmits the solicitation information to a plurality of communication terminals 3. The communication terminal 3b receives the solicitation information.

In Sq3, the communication terminal 3b generates application information as a response to the solicitation information, and transmits the application information to the server 5. The server 5 receives the application information.

In Sq4, the server 5 generates an application result based on the application information, and transmits the application result to the communication terminal 3a. The communication terminal 3a receives the application result from the server 5.

In Sq5, the communication terminal 3a transmits agreement information to the server 5, and the server 5 receives the agreement information.

In Sq6, the server 5 generates conclusion information based on the agreement information, and transmits the conclusion information to the communication terminal 3b. The communication terminal 3b receives the conclusion information.

In Sq7, the server 5 transmits guidance information to the communication terminal 3b. Upon receiving the guidance information, the communication terminal 3b displays the guidance information on the operation unit 35, and guides the second user 3b to the requested place of reception. Note that the portable electric power supply apparatus 1b may be an electric vehicle, and the communication terminal 3b may be a navigation apparatus installed in the electric vehicle. In this case, the navigation apparatus guides, or performs automated driving of, the electric vehicle to the requested place of reception in accordance with the guidance information.

<Flowcharts>

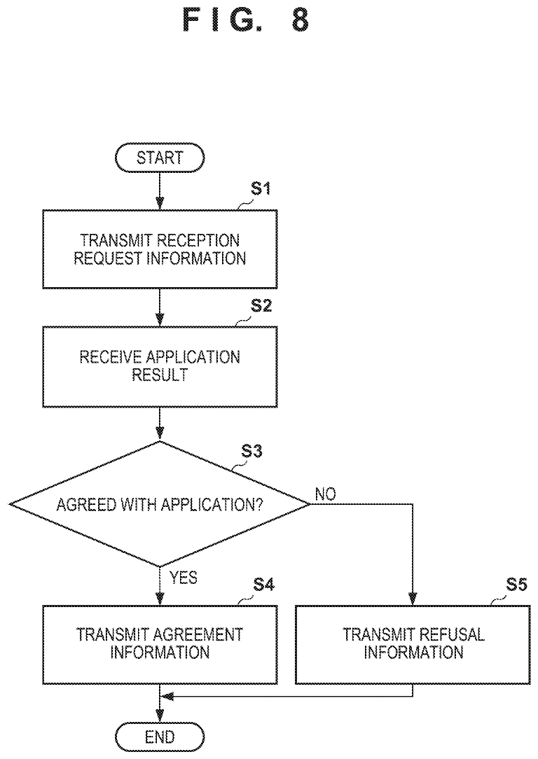

FIG. 8 is a flowchart showing a reception requesting method executed on the communication terminal 3a of the first user a who wishes to be a recipient.

In S1, the CPU 31 (reception request transmitting unit 37) generates reception request information in accordance with a transmission instruction input from the operation unit 35, and transmits the reception request information to the server 5.

In S2, the CPU 31 (application result receiving unit 38) receives an application result from the server 5. The application result receiving unit 38 displays the application result on the display apparatus of the operation unit 35.

In S3, based on an instruction input from the input apparatus of the operation unit 35, the CPU 31 (agreement information transmitting unit 39) determines whether to agree with an application. When an instruction indicating an agreement with the application has been input from the input apparatus of the operation unit 35, the agreement information transmitting unit 39 proceeds to S4. When an instruction indicating a refusal of the application has been input from the input apparatus of the operation unit 35, the agreement information transmitting unit 39 proceeds to S5.

In S4, the CPU 31 (agreement information transmitting unit 39) generates agreement information, and transmits the agreement information to the server 5.

In S5, the CPU 31 (agreement information transmitting unit 39) generates refusal information, and transmits the refusal information to the server 5.

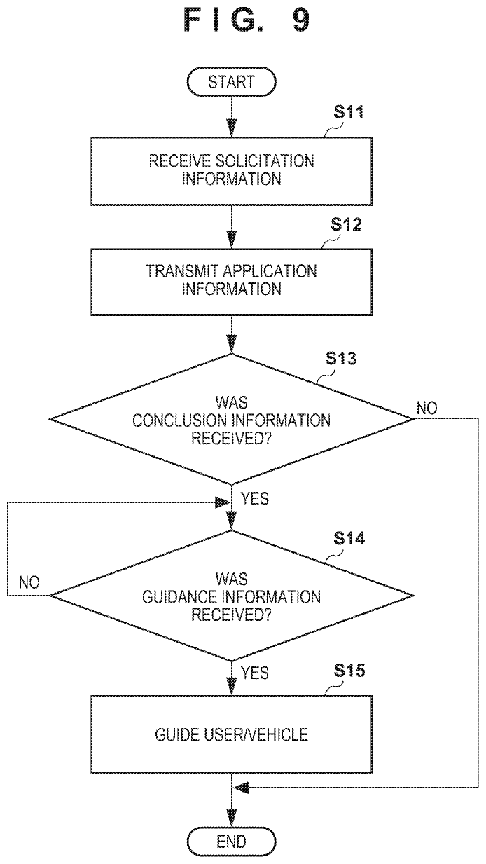

FIG. 9 is a flowchart showing a supply requesting method (an application method) executed on the communication terminal 3b of the second user b who wishes to be a supplier.

In S11, the CPU 31 (solicitation information receiving unit 40) receives solicitation information from the server 5. The solicitation information receiving unit 40 displays the solicitation information on the display apparatus of the operation unit 35, and accepts, from the input apparatus of the operation unit 35, an indication of the user's intention about whether to apply. Here, it is assumed that an indication of an intention to apply has been input.

In S12, the CPU 31 (application information transmitting unit 41) generates application information, and transmits the application information to the server 5. The application information includes, for example, a user ID, electric power specifications information, position information, and a communication address.

In S13, the CPU 31 (conclusion information receiving unit 42) determines whether agreement information (conclusion information) has been received from the server 5. When non-conclusion information has been received, the conclusion information receiving unit 42 ends the supply requesting method (application method). On the other hand, when the conclusion information has been received, the CPU 31 proceeds to S14.

In S14, the CPU 31 (guidance unit 43) stands by until guidance information is received. Upon receiving the guidance information, the CPU 31 proceeds to S15.

In S15, the CPU 31 (guidance unit 43) guides the user and an electric vehicle in accordance with the guidance information. For example, the guidance unit 43 displays a map on a display unit of the operation unit 35, and executes navigation from the current location to the requested place of reception. Alternatively, the guidance unit 43 performs automated driving of the electric vehicle to the requested place of reception by controlling a motor for driving wheels, a motor for driving a steering wheel, a motor for driving a brake, and the like of the electric vehicle in accordance with position information obtained from the GPS receiver 13 of the portable electric power supply apparatus 1, which is the electric vehicle, and with the guidance information.

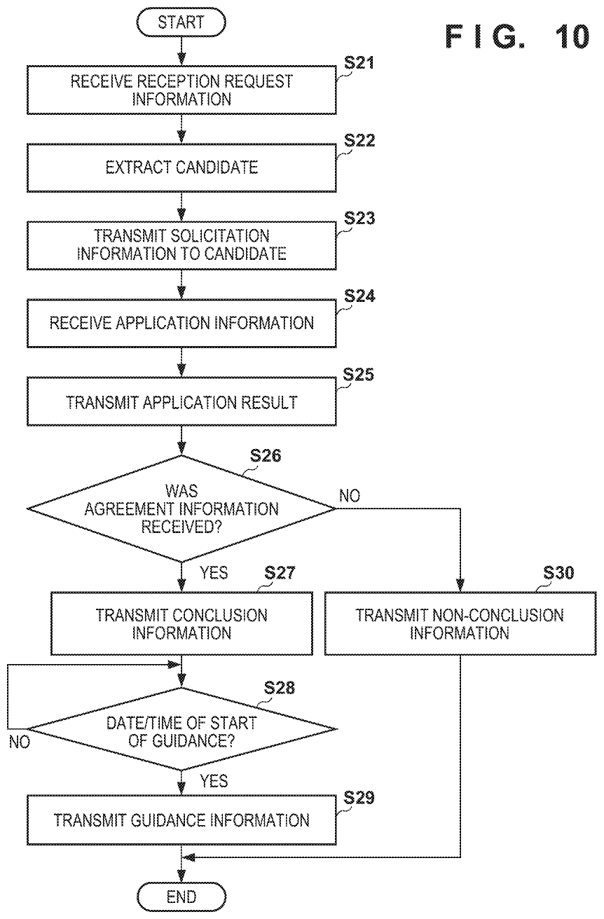

FIG. 10 is a flowchart showing a method of mediating lending of a portable electric power supply apparatus, which is executed on the server 5.

In S21, the CPU 51 (reception request receiving unit 54) receives reception request information from the communication terminal 3a.

In S22, the CPU51 (extraction unit 59) extracts, from the user DB 62, communication addresses and the like of candidates in accordance with reception conditions included in the reception request information.

In S23, the CPU51 (solicitation information transmitting unit 55) generates solicitation information based on the reception request information, and transmits the solicitation information to communication terminals 3 of the candidates extracted by the extraction unit 59.

In S24, the CPU 51 (application information receiving unit 56) receives application information from the communication terminals 3 of the candidates. Note that when the application information cannot be received within a predetermined period, the application information receiving unit 56 proceeds to S30.

In S25, the CPU 51 (application result transmitting unit 57) generates an application result based on the application information, and transmits the application result to the communication terminal 3a that transmitted the reception request information.

In S26, the CPU 51 (agreement information receiving unit 60) determines whether agreement information has been received from the communication terminal 3a. When the agreement information has been received, the CPU 51 proceeds to S27. Here, it is assumed that the second user b has been determined as a final lender (electric power supplier). On the other hand, when the agreement information cannot be received within the predetermined period or refusal information has been received, the CPU 51 proceeds to S30. In S30, the CPU 51 (conclusion information transmission unit 61) transmits non-conclusion information to the communication terminals 3 that transmitted the application information.

In S27, the CPU 51 (conclusion information transmission unit 61) transmits conclusion information to the communication terminal 3a. The conclusion information may include information of the departure time (the date/time of the start of guidance) of the second user b.

In S28, the CPU 51 (navigation unit 58) stands by until arrival of the date/time of the start of guidance. With reference to the map data 64, the navigation unit 58 determines a route and a required period from the position of the lender (second user b) to the requested place of reception. The navigation unit 58 further determines the date/time of the start of guidance by subtracting the required period from the requested date/time of reception. A margin period based on the distance of the route may be added to the required period. Upon arrival of the date/time of the start of guidance, the CPU 51 proceeds to S29.

In S29, the CPU 51 (navigation unit 58) transmits guidance information to the communication terminal 3b.

### SUMMARY

According to a first mode, a server apparatus is provided. The server 5 is an example of the server apparatus. The reception request receiving unit 54 and the communication circuit 53 are examples of a first receiver for receiving, from a communication terminal of a first user, reception request information that indicates a request for reception of electric power. The solicitation information transmitting unit 55 and the communication circuit 53 are examples of a first transmitter for transmitting, to a plurality of communication terminals, solicitation information for soliciting a user who wishes to supply electric power based on the reception request information among users who own portable electric power supply apparatuses. The application information receiving unit 56 and the communication circuit 53 are examples of a second receiver for receiving, from a communication terminal of a second user, application information as a response to the solicitation information. The application result transmitting unit 57 is an example of a second transmitter for transmitting the application information of the second user to the communication terminal of the first user. In this way, as the server apparatus mediates between a person who wishes to be a recipient and a person who wishes to be a supplier, the person who wishes to be the recipient can easily find the person who wishes to be the supplier. That is to say, lending and borrowing of a portable electric power supply apparatus can be promoted.

According to a second mode, each of the reception request information and the solicitation information may include information related to a requested date/time of reception of electric power, a requested place of reception of electric power, and an electric power amount of a portable electric power supply apparatus that supplies electric power.

According to a third mode, each of the reception request information and the solicitation information may include compensation information indicating compensation requested by the first user.

According to a fourth mode, each of the reception request information and the solicitation information may include information related to a date/time of return of the portable electric power supply apparatus or a place of return of the portable electric power supply apparatus.

According to a fifth mode, the user DB 62 is an example of a user database in which identification information of users who own portable electric power supply apparatuses, electric power amounts of the portable electric power supply apparatuses, and communication addresses of the users are stored in association with one another. The extraction unit 59 is an example of an extracting section for extracting, from the user database, respective communication addresses of a plurality of users who match the reception request information. In this case, the second transmitter may transmit the solicitation information to the plurality of communication terminals in accordance with the communication addresses extracted by the extracting section.

According to a sixth mode, a portable electric power supply apparatus 1 may be an engine-driven electric power generator or a portable storage battery.

According to a seventh mode, a portable electric power supply apparatus 1 may be a vehicle equipped with a storage battery for travelling purpose. The navigation unit 58 may transmit guidance information for the vehicle to the communication terminal of the second user so that the vehicle arrives at a place of supply of electric power requested by the first user by a date/time of supply of electric power requested by the first user.

According to an eighth mode, the vehicle may be an unmanned vehicle, a manned vehicle, or a drone that travels in accordance with the guidance information.

According to a ninth mode, the agreement information receiving unit 60 is an example of third receiver for, after the application information of the second user has been transmitted to the communication terminal of the first user, receiving agreement information indicating whether to agree with an application by the second user from the communication terminal of the first user. The conclusion information transmission unit 61 is an example of a third transmitter for transmitting the agreement information (conclusion information) of the second user to the communication terminal of the first user.

According to a tenth mode, the communication circuit 53 is an example of a communication circuitry for communicating with a plurality of communication terminals. The CPU 51 is an example of a control circuitry for controlling the communication circuitry. The communication circuit 53 may be controlled by the CPU 51 so as to: receive, from a communication terminal of a first user, reception request information indicating a request for reception of electric power; transmit, to a plurality of communication terminals, solicitation information for soliciting a user who wishes to supply electric power based on the reception request information; receive, from a communication terminal of a second user, application information as a response to the solicitation information; and transmit the application information of the second user to the communication terminal of the first user.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

What is claimed is:

1. A server apparatus comprising:
a first receiver configured to receive, from a communication terminal of a first user, reception request information that indicates a request for reception of electric power;
a first transmitter configured to transmit, to a plurality of communication terminals, solicitation information for soliciting a user who wishes to supply the electric power based on the reception request information among users who own portable electric power supply apparatuses;
a second receiver configured to receive, from a communication terminal of a second user, application information as a response to the solicitation information; and
a second transmitter configured to transmit the application information of the second user to the communication terminal of the first user,
wherein each of the reception request information and the solicitation information includes information related to a requested date/time of reception of the electric power, a requested place of reception of the electric power, and an electric power amount of a portable electric power supply apparatus that supplies the electric power.

2. The server apparatus according to claim 1, wherein
each of the reception request information and the solicitation information includes compensation information indicating compensation requested by the first user.

3. The server apparatus according to claim 1, wherein
each of the reception request information and the solicitation information includes information related to a date/time of return of the portable electric power supply apparatus or a place of return of the portable electric power supply apparatus.

4. The server apparatus according to claim 1, further comprising:
a user database in which identification information of users who own portable electric power supply apparatuses, electric power amounts of the portable electric power supply apparatuses, and communication addresses of the users are stored in association with one another; and
an extracting section configured to extract, from the user database, respective communication addresses of a plurality of users who match the reception request information,
wherein the second transmitter transmits the solicitation information to the plurality of communication terminals in accordance with the communication addresses extracted by the extracting section.

5. The server apparatus according to claim 1, wherein
the portable electric power supply apparatus is an engine-driven electric power generator or a portable storage battery.

6. The server apparatus according to claim 1, wherein
the portable electric power supply apparatus is a vehicle equipped with a storage battery for travelling purpose, and
the second transmitter transmits guidance information for the vehicle to the communication terminal of the second user so that the vehicle arrives at a place of supply of electric power requested by the first user by a date/time of supply of electric power requested by the first user.

7. The server apparatus according to claim 6, wherein
the vehicle is an unmanned vehicle, a maimed vehicle, or a drone that travels in accordance with the guidance information.

8. The server apparatus according to claim 1, further comprising:
a third receiver configured to, after the application information of the second user has been transmitted to the communication terminal of the first user, receiving agreement information indicating whether to agree with an application by the second user from the communication terminal of the first user; and
a third transmitter configured to transmitting the agreement information of the first user to the communication terminal of the second user.

9. A server apparatus comprising:
a communication circuitry configured to communicate with a plurality of communication terminals; and
a control circuitry configured to control the communication circuitry,
wherein
the communication circuitry is further configured to
receive, from a communication terminal of a first user, reception request information that indicates a request for reception of electric power,
transmit, to a plurality of communication terminals, solicitation information for soliciting a user who wishes to supply the electric power based on the reception request information,
receive, from a communication terminal of a second user, application information as a response to the solicitation information, and
transmit the application information of the second user to the communication terminal of the first user, and
each of the reception request information and the solicitation information includes information related to a requested date/time of reception of the electric power, a requested place of reception of the electric power, and an electric power amount of a portable electric power supply apparatus that supplies the electric power.
